(19) United States
(12) Patent Application Publication
(10) Pub. No.: US 2017/0344946 A1
(43) Pub. Date: Nov. 30, 2017

(54) Establishment Of A Delivery Route

(71) Applicant: SIEMENS AKTIENGESELLSCHAFT, MUENCHEN (DE)

(72) Inventor: THOMAS BAYER, HIRSCHAID (DE)

(21) Appl. No.: 15/531,312

(22) PCT Filed: Sep. 11, 2015
(86) PCT No.: PCT/EP2015/070796

§ 371 Date: May 26, 2017

(30) Foreign Application Priority Data
Nov. 28, 2014 (DE) 10 2014 224 452.8

(51) Int. Cl. G06Q 10/08; B07C 3/00

(52) U.S. Cl. CPC G06Q 10/08355; B07C 3/003

(57) ABSTRACT

A method for establishing a delivery route for delivering mail items includes calculating the delivery time of an upcoming delivery on the basis of data regarding previous delivery attempts, in order to avoid only being able to deliver the mail items after several delivery attempts. A sorting device for mail items is also provided.

The invention relates to a method for establishing a delivery route for delivering mail items. The invention further relates to a sorting device for the preparation of mail items sorted on the basis of a delivery route.

In known methods for establishing delivery routes, the delivery route is planned so that the route to be covered by the deliverer is as short as possible. It can occur herein that a recipient of the mail item is not reached during the delivery, so that the mail item cannot be delivered. The delivery of the mail item must therefore be planned anew. A second or further delivery attempts incur not insubstantial additional costs.

The object of the invention therefore lies in providing a method for establishing a delivery route with which a mail item can be delivered as far as possible on a first delivery attempt.

This object is achieved according to the invention for the method mentioned in the introduction in that for the method, data regarding previous delivery attempts is saved and for an upcoming delivery, on the basis of the stored data, a delivery time at which a successful delivery is more probable than at other delivery times is calculated and the delivery route is established on the basis of the calculated delivery times. This object is achieved according to the invention for the sorting device mentioned in the introduction in that the sorting device is configured to store data regarding previous delivery attempts and for upcoming deliveries and, on the basis of the stored data, to calculate a delivery time at which a successful delivery is more probable than at other possible delivery times, and to determine the delivery route on the basis of the calculated delivery times.

The establishment of the delivery route on the basis of the calculated delivery times enables the mail items to be delivered successfully more often, so that a renewed journey to the recipient is no longer necessary.

The delivery route is to be interpreted in the context of the present invention such that the delivery of an individual mail item that is delivered is also to be understood thereunder. The mail item can be, for example, a letter, a package or another item that is delivered.

The inventive solution can be further improved by means of different embodiments, each per se advantageous and, provided not otherwise stated, freely combinable with one another. These embodiments and the advantages associated with them will now be considered.

Thus for the calculation of the delivery time, only data from previous delivery attempts to the same recipient can be used. The delivery time can thus be specifically calculated for the respective recipient of the mail item, so that the probability that the delivery attempt can be carried out successfully at the calculated delivery time is further increased.

Preferably, the data regarding the previous delivery attempts has the date, the time and information regarding whether the delivery attempt was successful. For example, it can be that a recipient of the mail item works during the week and therefore has only been reached on Saturdays, for example at around eleven o'clock in the morning. Consequently, the data can contain information which indicates that delivery attempts on selected days and/or at selected times was successful and/or on other days and/or at other times was not successful.

Since it can occur that recipients of the mail item cannot always be reached at a particular time, but rather are not reached on selected days and at selected time points, at least sometimes, the data regarding the previous delivery attempts can comprise the number of unsuccessful delivery attempts for previous mailings. Thus despite at least occasional unsuccessful delivery attempts, the probability of a success of a delivery attempt at a pre-determined time point can be ascertained.

The data regarding the previous delivery attempts can comprise data regarding the sender, the volume, the weight and/or the type of the mail item. Thus it can be, for example, that the recipient of the mail item is waiting for mail items from particular senders and is therefore to be found at the delivery address, for example, at home. Dependent also on the volume or weight and, in particular, for large volume and/or particularly heavy mail items, it can be that the recipient is waiting at the delivery address, for instance at home, for the delivery of the mail item. Furthermore, dependent upon the type of the mail item, the recipient can be waiting for the delivery of the mail item. For example, the mail item can be a perishable good for which the recipient is waiting at the delivery address, for instance at home.

It can occur that a recipient of the mail item is repeatedly not to be found at possible, and even at different delivery times and the mail item is therefore repeatedly not deliverable. In order nevertheless to be able to deliver the mail item, the data regarding the previous delivery attempts can comprise information regarding acceptors of mailings who differ from the recipient. Such acceptors can be neighbors, adjacent firms or a packet box from which the recipient can fetch the mail item at any time. Consequently, the delivery route can be determined such that after a first planned delivery attempt to the recipient, the acceptor differing from the recipient is or will be planned into the delivery route in the same or a subsequent delivery route. If the data shows that it has not previously been possible to deliver the mail item successfully to the recipient at all, then the delivery route can also planned bypassing the recipient, directly to the acceptor differing from the recipient.

The data regarding the previous delivery attempts can comprise data regarding weather conditions prevailing during successful and/or unsuccessful delivery attempts. It can thus be the case that the recipient of the mail item is to be found readily during bad weather, for instance rain, so that the mail item can be delivered successfully. During good weather conditions, there may possibly be a high probability that the recipient will not be found at the intended delivery point if, for example, the recipient often goes for a walk during good weather conditions.

The data regarding the previous delivery attempts is preferably continuously collected in a database for all delivery attempts of a delivering organization. The data is therefore not only collected for one recipient, but for all recipients of mail items who the delivering organization visits. The data can also be collected for a plurality of organizations, for example, for a whole country. By this means, the basis of the data of the database is broadened so that the predictability of whether the delivery will be successful at the calculated delivery time is improved.

In order to be better able to determine the delivery time at which a successful delivery is probable, further data regarding the recipient can be stored and used during the calculation of the delivery time. The further data can state, for example, whether the recipient is a self-employed businessperson who at least occasionally works at home. Furthermore, the further data can contain information regarding whether children live in the household of the recipient, so that a delivery during the school vacations is possibly more probable, since then the children are often looked after at home.

Preferably, recipient data regarding the previous delivery attempts is determined and used for the calculation of the delivery time of upcoming deliveries before the delivery begins. For example, delivery times for all the upcoming deliveries of a following day can be calculated at the end of the previous day so that the delivery route is completely available when the delivery of the mail item begins on the following day.

The delivery times are preferably calculated after all delivery attempts of the previous day have been completed and data relating thereto has been stored. The calculated delivery times of the following day are therefore based on current data.

If a probability value representing the probability of a successful delivery for all possible delivery times lies below a target value, then on the basis of the data regarding the previous delivery attempts, it can be decided to move the delivery of the mail item by at least one day. Consequently, an unnecessary journey to the recipient can be avoided.

In order that delivery times at which a delivery is probably successful are available at all times, the delivery time can be calculated even if currently no mail item is to be delivered to the recipient. Delivery times at which the delivery is probable can be calculated, for example, once per week or even daily, so that the calculated delivery times are currently available.

In order to simplify the delivery for the deliverer, delivery options can be determined and made available together with the calculated delivery time. Delivery options can include acceptors who differ from the recipient. Furthermore, delivery options can contain information regarding animals in the household of the recipient, for example snappy dogs, and behavioral recommendations.

The method is preferably carried out on a data processing apparatus in order to ensure a rapid and efficient calculation of the delivery times. The sorting device can comprise the data processing apparatus. The data processing apparatus is, for example, a computer with a microprocessor. Furthermore, an existing data processing apparatus of a sorting device can be exchanged for an inventive data processing apparatus in order to be able to retrofit the improved route planning. The data processing apparatus can therefore be a retrofit kit for a sorting device. Furthermore, the inventive method can be present on a data carrier, for example, an optical data carrier, a hard disk or other transportable or firmly installed data carriers, the data carrier being connectable to the data processing apparatus to transfer data, in order to be able to install the improved route planning on the data processing apparatus.

The above-described properties, features and advantages of this invention and the manner in which these are achieved will now be described more clearly and explicitly with the following description of the exemplary embodiments, and by reference to the drawings, in which:

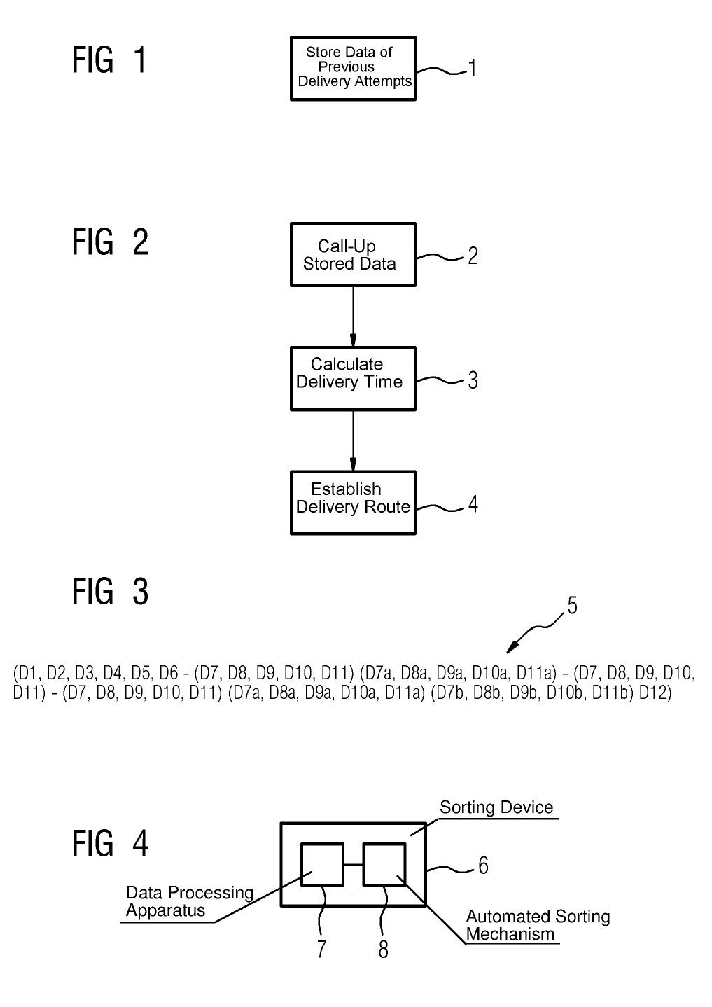

FIG. 1 shows a schematic illustration of the storage of data regarding previous delivery attempts,

FIG. 2 shows a schematic illustration of the calculation of a delivery time on the basis of the stored data,

FIG. 3 shows a schematic representation of a data set of stored data, and

FIG. 4 shows a schematic representation of an exemplary embodiment of an inventive sorting device.

The invention will now be described by way of example on the basis of embodiments relating to the drawings. The different features of the embodiments can be combined independently of one another, as already shown with the individual advantageous embodiments.

FIG. 1 shows schematically an exemplary method step 1 of an exemplary embodiment of the inventive method wherein, in method step 1, data regarding the previous delivery attempts is stored.

FIG. 2 shows an exemplary embodiment of the inventive method in which a delivery time is calculated, the method steps shown being schematically represented in a flow diagram.

In the method step 2, the data stored in method step 1 is called up. Optionally, method step 1 can be part of the method shown in FIG. 2 and can be carried out before method step 2.

In method step 3 following method step 2, the delivery time is calculated on the basis of the data called up in method step 2. Method step 3 can be carried out anew for selected, for example large or heavy, mail items or for all the deliveries to be carried out, before the method is continued with other method steps.

In the method step 4 following method step 3, the delivery route is established on the basis of the calculated delivery times for all the mail items to be delivered along the delivery route.

FIG. 3 shows, for example, a data set of data stored, for example, in method step 1 regarding previous delivery attempts. Data items D1 to D6 can herein contain address information of the recipient. D1 represents herein, for example, the surnames, D2 the first names, D3 the street name, D4 the house number, D5 the postal code and D6 the town/city in which the recipient lives.

The address data D1 to D6 can be followed by data regarding deliveries of mailings to the recipient, wherein the data items regarding the deliveries are separated from the address data and from one another by a separator represented, for example, as a hyphen.

For the first delivery following the address data, two delivery attempts were necessary in order to deliver the mail item, for example, a packet. These two delivery attempts are shown, by way of example, by the two groups of data D7 to D11 and D7a to D11a, each shown in parentheses. The data D7 and D7a represent the number of delivery attempts. Preferably, D7 represents the one for the first delivery attempt and D7a the two for the second delivery attempt. The data D8 to D10 or D8a to D10a represent a time stamp at which the delivery attempt succeeded. The time stamp can represent the time, the day, the month and optionally also the year of the delivery attempt. For example, the time can be represented in quarter-hourly increments. The data D11 and D11a represent whether the delivery attempt was successful. Since the first delivery attempt was not successful, D11 represents, for example, the number zero. On the second delivery attempt, the mail item could be delivered so that D11a represents, for example, the number one.

Data representing a second delivery of a further mailing follows, again separated by the separator, shown by way of example as a hyphen, from the first delivery. The second delivery was successful in the first attempt so that only the data D7 to D11 is represented between parentheses.

On a third delivery of another mailing, three delivery attempts were carried out. Data which represents the third delivery is separated from the data representing the second delivery, again by the separator. However, all three delivery attempts were unsuccessful, so that the data D11, D11a and D11b represent an unsuccessful delivery and, for example, the number zero. Since the delivery was unsuccessful and the mail item could not be delivered to the recipient, the mail item was delivered to an acceptor differing from the recipient, this being represented by the field D12. For example, D12 can represent data regarding the acceptor, for example, the name of the receiving neighbor or the packet box in which the mail item was left for the recipient.

FIG. 4 shows schematically an exemplary embodiment of an inventive sorting device for sorted preparation of mail items on the basis of a delivery route.

The sorting device 6 is configured to carry out the inventive method and, in particular, to store data regarding previous delivery attempts and for upcoming deliveries on the basis of the stored data to calculate a delivery time at which a successful delivery is more probable than at other possible delivery times and to establish the delivery route on the basis of the calculated delivery times. Using the delivery route established on the basis of the calculated delivery times, the sorting device 5 can order the mail items in a sorted manner. In order to calculate the delivery route, the sorting device 5 can comprise a data processing apparatus 7 which can be connected in a data or signal-transferring manner to an automated sorting mechanism 8 of the sorting device 5.

1-15. (canceled)

16. A method for establishing a delivery route for the delivery of mail items, the method comprising the following steps:
storing data regarding previous delivery attempts;
using the stored data to calculate a delivery time for an upcoming delivery at which a successful delivery is more probable than at other possible delivery times; and
establishing the delivery route based on the calculated delivery times.

17. The method according to claim 16, which further comprises only using data from the previous delivery attempts to the same recipient for the calculation of the delivery times.

18. The method according to claim 16, which further comprises providing a date, a time and information regarding whether or not the delivery attempt was successful, in the data regarding the previous delivery attempts.

19. The method according to claim 16, which further comprises providing a number of unsuccessful delivery attempts for previous mailings, in the data regarding the previous delivery attempts.

20. The method according to claim 16, which further comprises providing data regarding at least one of a sender, a volume, a weight or a type of the mail item, in the data regarding the previous delivery attempts.

21. The method according to claim 16, which further comprises providing information regarding acceptors differing from a recipient, in the data regarding the previous delivery attempts.

22. The method according to claim 16, which further comprises providing data regarding weather conditions prevailing during at least one of successful or unsuccessful delivery attempts, in the data regarding the previous delivery attempts.

23. The method according to claim 16, which further comprises continuously collecting the data regarding the previous delivery attempts in a database for all delivery attempts of a delivering organization.

24. The method according to claim 16, which further comprises storing further data regarding a recipient.

25. The method according to claim 16, which further comprises calculating the delivery time before beginning the delivery.

26. The method according to claim 16, which further comprises deciding to move the delivery of the mail item by at least one day, based upon the data regarding the previous delivery attempts.

27. The method according to claim 16, which further comprises calculating the delivery time even if no mail item is to be delivered.

28. The method according to claim 16, which further comprises determining and making available delivery options together with the calculated delivery time.

29. The method according to claim 16, which further comprises carrying out the method on a data processing apparatus.

30. A sorting device for the sorted preparation of mail items based on a delivery route, the sorting device comprising an apparatus configured to:
store data regarding previous delivery attempts;
use the stored data to calculate a delivery time for upcoming deliveries at which a successful delivery is more probable than at other possible delivery times; and
establish the delivery route based on the calculated delivery times.
